(19) United States
(12) Patent Application Publication
(10) Pub. No.: US 2022/0056988 A1
(43) Pub. Date: Feb. 24, 2022

(54) SLIDE RAIL FOR A BELT-DRIVE TRANSMISSION

(71) Applicant: Schaeffler Technologies AG & Co. KG, Herzogenaurach (DE)

(72) Inventor: Nicolas Schehrer, Eschau (FR)

(73) Assignee: Schaeffler Technologies AG & Co. KG, Herzogenaurach (DE)

(21) Appl. No.: 17/417,212

(22) PCT Filed: Dec. 12, 2019
(86) PCT No.: PCT/DE2019/101081

§ 371 Date: Jun. 22, 2021

(30) Foreign Application Priority Data
Jan. 9, 2019 (DE) 10 2019 100 401.2
Apr. 3, 2019 (DE) 10 2019 108 714.7

(51) Int. Cl. F16H 7/18; F16H 9/18

(52) U.S. Cl. CPC F16H 7/18; F16H 2007/0872; F16H 2007/185; F16H 9/18

(57) ABSTRACT

A slide rail for a belt-drive transmission includes a slide channel and a pivoting receptacle. The slide channel includes a first slide surface for damping contact on a strand of a belt of the belt-drive transmission, a second slide surface for damping contact on the strand, antagonistic to the first slide surface, and a channel height formed by the first slide surface and the second slide surface. The pivoting receptacle is arranged for pivoting support of the slide rail on a pivoting means of the belt-drive transmission. A one of the first slide surface or the second slide surface includes an elevation extending toward the belt such that the one of the first slide surface or the second slide surface is displaced over a profile along a longitudinal direction in a transversal direction.

### CROSS-REFERENCE TO RELATED APPLICATIONS

This application is the United States National Phase of PCT Appln. No. PCT/DE2019/101081 filed Dec. 12, 2019, which claims priority to German Application Nos. DE102019100401.2 filed Jan. 9, 2019 and DE102019108714.7 filed Apr. 3, 2019, the entire disclosures of which are incorporated by reference herein.

### TECHNICAL FIELD

The present disclosure relates to a slide rail for a belt-drive transmission, a belt-drive transmission having such a slide rail for a drive train, a drive train having such a belt-drive transmission, and a motor vehicle having such a drive train.

### BACKGROUND

A belt-drive transmission, also referred to as a belt-driven conical pulley transmission or CVT (continuous variable transmission), for a drive train, for example of a motor vehicle, includes at least one first cone pulley pair arranged on a first shaft and a second cone pulley pair arranged on a second shaft, as well as a belt provided for torque transmission between the cone pulley pairs. A cone pulley pair includes two cone pulleys which are oriented with corresponding conical surfaces to each other and are axially movable relative to each other. The (first) cone pulley, also known as a loose pulley or movable pulley, can be displaced along the shaft axis thereof and the (second) cone pulley, also known as a fixed pulley, is fixed in the direction of the shaft axis. Such belt-drive transmissions have long been known, for example from DE 100 17 005 A1.

Due to the conical surfaces of the cone pulleys, the belt is displaced during operation of the belt-drive transmission in a radial direction between an inner position (small radius of action) and an outer position (large radius of action) by means of the relative axial movement of the cone pulleys of one of the cone pulley pairs. The belt thus runs on a variable radius of action, i.e., with a variable running radius. As a result, a different rotational speed transmission ratio and torque transmission ratio can be continuously adjusted from one cone pulley pair to the other cone pulley pair.

The belt forms two strands between the two cone pulley pairs, and, depending on the configuration and the direction of rotation of the cone pulley pairs, one of the strands forms a driving strand and the other strand forms a slack strand or a load strand and an empty strand.

The direction perpendicular to the (respective) strand and pointing from the inside to the outside or vice versa is called the transversal direction. The transversal direction of the first strand is therefore parallel to the transversal direction of the second strand only if the running radii on the two cone pulley pairs are the same. The direction perpendicular to the two strands and pointing from one cone pulley to the other cone pulley of a cone pulley pair is referred to as the axial direction. Thus, this is a direction parallel to the axes of rotation of the cone pulley pairs. The third spatial direction in the (ideal) plane of the (respective) strand is called the travel direction or the opposite travel direction or the longitudinal direction. The travel direction, transversal direction, and axial direction thus span a Cartesian coordinate system that moves along therewith (during operation). The aim is that the travel direction forms the ideally shortest connection between the adjacent running radii of the two cone pulley pairs, but in dynamic operation the alignment of the respective strand can deviate temporarily or permanently from this ideally shortest connection.

In such belt-drive transmissions, at least one damper apparatus is provided in the space between the cone pulley pairs. Such a damper apparatus can be arranged on the driving strand and/or on the slack strand of the belt and serves to guide and thus to limit vibrations of the belt. Such a damper apparatus is to be designed primarily with regard to an acoustically efficient traction means guide (belt guide). The length of the adjacent (slide) surface for guiding the belt and the rigidity of the damper apparatus are decisive influencing factors. A damper apparatus is designed, for example, as a slide shoe or as a slide guide with only one-sided, usually installation space-dependent (transverse to the belt) inside slide surfaces, i.e., arranged between the two strands.

Alternatively, the damper apparatus is designed as a slide rail having a slide surface on both sides, i.e., both on the outside, i.e., outside of the belt circle formed, and also on the inside slide surface for the relevant strand of the belt formed. A slide surface is also referred to as a guide surface. In the case of a slide rail, the two transversely opposite slide surfaces, i.e., antagonistic or antagonistically acting on the strand to be damped, are jointly referred to as a guide channel or slide channel.

The damper apparatus is mounted by means of a pivoting receptacle on a pivoting means having a pivot axis, which enables a pivoting of the damper apparatus about the pivot axis. In some applications, the damper apparatus can also be moved transversely, so that the damper apparatus follows a (steeper oval) curve which deviates from a circular path around the pivot axis. The pivot axis thus forms the center of a (two-dimensional) polar coordinate system, and the (pure) pivot movement thus corresponds to the change in the polar angle and the transverse movement corresponding to the change in the polar radius. This translational movement, which is overlaid, i.e., superimposed, on the pivot movement, is disregarded below for the sake of clarity and is summarized under the term pivot movement. The pivot axis is oriented transversely to the travel direction of the belt, i.e., axially. This ensures that when the radii of action (running radii) of the belt-drive transmission are adjusted, the damper apparatus can be guided following the resulting new (tangential) alignment of the belt.

Damper devices are currently made of plastic, for example a low-friction polyamide, for example polyamide, preferably PA46. The change in expansion of the belt, for example a chain made of steel, is less than that of the plastic of the damper device, which can be problematic for the slide channel of a slide rail in terms of too high a holding force due to excessive clamping and in terms of good acoustic efficiency over the entire operating temperature range.

In the prior art, the slide channel of a slide rail is divided into three main regions, namely two edge regions (also referred to as chain inlet and chain outlet) and a central region in the vicinity of a web (transversely connecting the slide surfaces), which is referred to here as the central region. According to the prior art, the central region has a greater channel height than in the edge region and the transitions between the edge region and the central region. In the prior art, the slide channel of a slide rail is designed to be flat, with a deviation from this with a channel widening in the central region (web region) in order to prevent the slide rail from jamming the belt with too high a force during a cold start (low temperature).

As a result of an operational temperature increase in the belt-drive transmission, the volume of the plastic of the slide rail changes, so that the slide rail geometry, e.g., the slide channel, changes. One reason for the greater channel height in the central region of the slide rail compared to its edge regions is to prevent the belt from being excessively clamped in the central region of the slide rail at low temperatures. The central region of the slide rail is namely stiffer than its edge regions because the central region is arranged in the vicinity of the web (transversely connecting the slide surfaces). This structure leads to the fact that at operating temperature in the central region there is more play between the slide rail and the belt than is necessary. The potential acoustic effectiveness of the slide rail is therefore not fully exploited. The type of contact between the slide channel and the belt is a decisive factor for the ability of a slide to calm vibrations of the belt.

### SUMMARY

The present disclosure relates to a slide rail for a belt-drive transmission, having a slide channel with a channel height formed from two antagonistic slide surfaces, each for damping contact on a strand of a belt of a belt-drive transmission, and a pivoting receptacle for pivoting support of the slide rail on a pivoting means of a belt-drive transmission. The first slide surface and/or the second slide surface may have at least one elevation toward the belt such that the slide channel is displaced over the profile along the longitudinal direction in the transversal direction.

In the following, if the axial direction, transversal direction, or the travel direction and corresponding terms are used without explicitly indicating otherwise, reference is made to the mentioned spatial directions that move along therewith. Unless explicitly stated otherwise, ordinal numbers used in the previous and subsequent descriptions are used only for the purposes of clear distinction and do not indicate the order or ranking of the designated components. An ordinal number greater than one does not necessarily mean that another such component must be present.

According to the prior art, the slide rail is set up for guiding or damping a belt or at least one strand of a belt of a belt-drive transmission. The belt and the belt-drive transmission are designed, for example, as is previously known. The belt is, for example, a link chain with rocker pressure pieces in a traction mechanism drive or a push link belt in a push link drive.

The slide rail includes two antagonistic slide surfaces, respectively designed to rest against the belt in a region shaped as a strand. The slide channel has a channel height which corresponds to the transversal distance between the two antagonistic slide surfaces.

So that the slide surfaces can be tracked corresponding to the (target) alignment of the strand to be guided, a pivoting receptacle is provided for a pivoting means bearing the slide rail. The pivoting means is often designed as a stationary component, for example as a tube, and a relative movement takes place between the bearing surface and the pivoting means when the slide rail follows the changed alignment of the strand. The pivoting means supports the slide rail in a pivotable manner. By means of the pivoting receptacle, the slide rail is pivotably supported on a pivoting means of a belt-drive transmission.

For many applications the slide rail may be designed in several parts, for example in two parts, for example for simple assembly into a belt-drive transmission. Two or more separate carrier bodies are then provided, which are mechanically connected to one another, for example in a form-fitting and/or force-fitting manner, for example interconnected as a 1-click rail. In an example embodiment, two carrier bodies are provided which are each structurally identical with regard to the at least one slide surface and the bearing surface, or are entirely identical. The two carrier bodies may each have one, for example the same, portion of the respective slide surface and/or the pivoting receptacle.

It is now proposed here that the first slide surface and/or the second slide surface has at least one elevation such that the slide channel is displaced over the profile along the longitudinal direction in the transversal direction. For example, an elevation is at its maximum a transverse height of at least 10 μm [ten micrometers] and is therefore not a manufacturing-related deviation (tolerance). In one embodiment, the displacement is a maximum of 30% [thirty percent] of the channel height, in one embodiment at least 1% to a maximum of 20% of the channel height. In one embodiment, this results in an undulating or a curved profile for the strand of the belt to be guided. In one embodiment, the slide channel is designed in such a way that an at least simply transversely outwardly curved path can be run on for the strand to be guided.

In one embodiment, the slide channel is designed in such a way that an undulating path can be run on for the strand to be guided. In one embodiment, the slide channel is designed such a way that the strand to be guided is forced to follow an (approximately) ideally straight profile in the longitudinal direction at least in one (preferably frequent) or in a plurality of vibration states, but the run comes into abutting contact with at least one, preferably both, slide surfaces only in places, preferably several times. This creates a clamping, i.e., holding force on the strand to be guided and/or an (at least local) bending of the slide channel, with which targeted damping can be achieved. In one embodiment, the location of an elevation or a plurality of elevations is arranged at a (longitudinally) predetermined location which is adapted to a common vibration pattern and/or to a specific operating point of the strand. The reaction force should not be set too high so that the holding force or the running resistance does not become too great. This is ensured below 30% of the channel height, but at least a displacement below 20% of the channel height and a steadily rising or falling slope.

In a particular embodiment, the strand can lift off the inner (for example first) slide surface transversely on the inside, i.e., toward the other strand or, in most embodiments, on the pivoting means side. In the case of an ideal profile of the strand, i.e., aligned without vibrations and tangentially to the radii of action, the strand remains in contact with the inner (e.g., first) slide surface, while as a result of the increased channel height the outer (e.g., second) slide surface is lifted transversely outwards from the (ideally running) strand. In a particular embodiment, a (permissible) clamping is formed in at least one edge region, i.e., at the entry and/or at the exit of the belt, in at least one operating state. As a result of the more rigid belt, the slide channel is bent open in the region of the clamping and the shape of the slide channel is changed in the course of the longitudinal direction. This change in the shape of the slide channel is dependent, for example, on the shape and amplitude of the vibration (i.e., the transverse vibration force) of the belt. For example, a central region that is curved transversely outwardly without a belt is bent further transversely inward as a result of the clamping of the belt with at least one edge region, for example, up to a contact with the belt. For this, the inner (for example the first) slide surface may be designed to be flat.

If the channel height is changed over the profile along the longitudinal direction, the two slide surfaces approach one another transversely or are transversely spaced further apart. This shape may deviate from a mere widening of the slide channel in the central region, for example, such an extension is not provided in the central region. For example, regardless of the provision of such a previously known widening in the central region of the at least one elevation, the channel height is changed, for example reduced. For example, the channel height is narrowed, for example not only in the edge regions or only outside the edge regions, for example in the central region.

If the channel height is displaced over the profile in the transversal direction. this means an inclined, curved or undulating profile in the longitudinal direction of the slide channel. If the channel height is only displaced along the longitudinal direction, the two antagonistic slide surfaces run parallel to one another.

For example, the at least one elevation in the relevant slide surface alone defines the contact surface for direct (sliding) contact of the relevant slide surface with the belt. Then no further section of the slide surface is in contact with the strand of the belt. The contact surface, and all or part of the remaining slide surface, for example, is designed with regard to low friction or low wear at least on the belt. For example, the contact surface has a gentle slope, a low surface roughness and/or self-lubricating properties. The fact that the elevation or the plurality of elevations alone forms the contact surface applies under the assumption of an ideally straight alignment of the strand to be damped, i.e., the vibration-free strand, and/or in the case of a strand with a predetermined vibration pattern. For example, the at least one elevation alone defines the contact surface at a predetermined temperature, for example room temperature or an operating temperature or an operating temperature range.

A transition to an elevation may be continuous, such that the strand to be guided does not encounter an impact surface, but rather is tangentially diverted and/or continuously changed, for example rising in the direction of travel of the strand, with a force applied in the transversal direction. The efficiency of the belt-drive transmission is therefore not or only negligibly impaired.

It is also proposed in an example embodiment of the slide rail that a material recess is formed on the rear of at least one slide surface, e.g., in a region:

of a reduced channel height; and/or
of an elevation of the slide surface in question, projecting in the transversal direction toward a belt.

A material recess causes a local reduction in the rigidity of the slide surface. Thus, a force-dependent variability of the channel geometry can be generated, and thus a variability dependent on a vibration state of the strand of the belt to be damped. The arrangement of the at least one material recess is selected, for example, as a function of possible vibration states (with respectively known vibration patterns), for example with regard to the remaining wall thickness between the material recess and the slide channel and/or with regard to the longitudinal position, i.e., for example, in the case of a vibration antinode at a natural frequency of the strand to be damped.

The at least one material recess may be provided with a reduced channel height (constriction) so that the slide channel can be bent open there, for example, with no or reduced influence on the remaining geometry of the slide rail, e.g., the slide channel. Thus, according to a further aspect, a holding force is reduced in comparison to an embodiment with solid material in the event of clamping because the slide surface there is (transversely) less rigid.

The material recess may be provided at an elevation in one of the slide surfaces. For example, by means of a vibration or bulging of the strand of the belt in the slide channel in a transverse-outward direction, the height of the elevation from the force-transmitting strand is reduced to leveled or, on the contrary, is pressed transversely under the rest of the slide surface. A great variability in the (contact-active) contact surface can thus be achieved.

It is further proposed in an example embodiment of the slide rail that a central region has a first channel height and an edge region has a second channel height, and the second channel height is lower than the first channel height.

Here the channel height is displaced over the longitudinal profile in the transversal direction. There is therefore no channel widening that bulges out on both sides in the central region. The displacement of the channel height is defined, for example, on one (for example second) slide surface and the other (for example first) slide surface runs differently from this, so that an increase in the channel height occurs. If, on the contrary, a channel expansion bulging out on both sides occurs, a displacement in the height of the channel cannot be referred to. Rather, this corresponds to a release of the strand of the belt to be guided with no or a significantly reduced damping effect. For example, the inner (for example first) slide surface is in contact with the strand in the case of an ideally tangential profile of the strand, e.g., over the entire surface. For example, the outer (for example second) slide surface is only in contact with the strand outside the edge regions when there is a maximum transverse acceleration of the strand. For example, both slide surfaces are at least for the most part permanently in contact with the strand, and the clamping is different due to the different channel heights over the profile.

It is further proposed in an example embodiment of the slide rail that a central region has a first channel height and an edge region has a second channel height, and the first channel height is lower than the second channel height.

Here, the channel height is displaced over the profile in the longitudinal direction (see the explanations above). The displacement of the channel height is defined, for example, on one (for example second) slide surface and the other (for example first) slide surface runs differently from this, so that a reduction in the channel height occurs from a (narrowed) edge region to the central region. For example, the outer (for example second) slide surface is in contact with the strand in the case of an ideally tangential profile of the strand, e.g., over the entire surface. For example, the inner (for example first) slide surface is only in contact with the strand when there is a maximum transverse acceleration of the strand outside the central region. This embodiment works well in connection with a material recess according to the above description, e.g., only in the central region. (transversely) on one side or on both sides of the slide channel.

It is also proposed in an example embodiment of the slide rail that the first slide surface is flat and the antagonistic second slide surface is curved.

In this embodiment, for example, the outer (for example first) slide surface is in contact with the strand in the case of an ideally tangential profile of the strand, e.g., over the entire surface. For example, the inner (for example second) slide surface is only in contact with the strand when there is a maximum vibration of the strand outside the edge regions. In one embodiment, the outer slide surface is the curved second slide surface and the inner slide surface is the flat first slide surface. For example, the inner (i.e., for example, first) slide surface is in contact with the strand in the case of an ideally tangential profile of the strand, e.g., over the entire surface, and the outer (i.e., for example, second) slide surface is in contact with the ideally curved profile (at the latest at maximum acceleration towards the transversal-outside) of the strand, e.g., over the entire surface, in contact with the strand. A good acoustic efficiency is thus achieved in at least two states of the strand due to a large contact region.

It is also proposed in an example embodiment of the slide rail that the first slide surface and the antagonistic second slide surface are designed to run parallel to one another.

In this embodiment, the strand to be guided is always at an elevation for an ideally straight longitudinal profile or only one or more antinodes in the path, so that almost every excited vibration of the strand to be guided is disturbed. This creates good acoustic efficiency with a simple geometry of the slide channel. In an example embodiment, the channel height is set in such a way that, at least assuming an ideally deformable strand, a play is always set so that a transversely acting force is introduced onto the strand only to deflect the strand. e.g., in the form of a constant change in force. For example, a tangential (i.e., over the entire longitudinal extent) constant (theoretical) minimum distance between the antagonistic slide surfaces is set in such a way that an ideally tangential strand runs through the slide channel without contact or at least with negligible friction or holding force. A (force-transmitting) contact does not occur until an antinode occurs.

According to a further aspect, a belt-drive transmission is proposed for a drive train, having at least the following components:

a transmission input shaft having a first cone pulley pair,
a transmission output shaft having a second cone pulley pair;
a belt by means of which the first cone pulley pair is connected to the second cone pulley pair in a torque-transmitting manner and which forms two strands between the two cone pulley pairs; and
at least one slide rail according to an embodiment according to the above description, wherein the at least one slide rail for damping the belt rests with the slide surfaces on one of the strands of the belt.

With the belt-drive transmission proposed here, a torque can be transmitted from a transmission input shaft to a transmission output shaft, and vice versa, in a step-up or step-down manner, and the transmission can be continuously adjusted, at least in some regions. A belt-drive transmission is designed, for example, as shown at the outset, and the slide rail fulfills the task explained at the outset.

The components of the belt-drive transmission are usually enclosed and/or supported by a transmission housing. For example, the pivot bearing for the pivoting receptacle is mounted as a bearing tube to the transmission housing and/or is movably supported thereon. The transmission input shaft and the transmission output shaft extend from outside into the transmission housing and may be supported on the transmission housing by means of bearings. The cone pulley pairs are housed by means of the transmission housing, and the transmission housing may form the abutment for the axial actuation of the movable cone pulleys. Furthermore, the transmission housing may form connections for attaching the belt-drive transmission and, for example, for the supply of hydraulic fluid. For this purpose, the transmission housing has a large number of boundary conditions and must fit into a given installation space. This interaction results in an inner wall that limits the shape and movement of the components. This represents the decisive limitation for the pivotable slide rail, for example, so that the shape must be constructed on the basis of the transmission housing or the inner wall thereof to achieve the best possible damping property.

The belt-drive transmission proposed here has one or two slide rails, of which at least one slide rail according to the above description has a particularly good damping property with the exclusion of an excessive clamping effect with at the same time low wear effects on the belt and/or the slide rail. This is achieved by displacing the channel height of the slide channel.

According to a further aspect, a drive train is proposed, having at least one drive assembly with an input shaft, at least one consumer and a belt-drive transmission according to an embodiment as described above. The drive shaft for torque transmission by means of the belt-drive transmission can be connected with the at least one consumer with a changeable transmission ratio.

The drive train is designed to transmit a torque provided by one or a plurality of drive units, for example an internal combustion engine and/or an electric machine, and output via the respective drive shaft thereof, i.e., the combustion drive shaft and/or the electric drive shaft (rotor shaft), for example, for use by a consumer as required, i.e., taking into account the required speed and the required torque. One use is, for example, an electrical generator to provide electrical energy or the transmission of torque to a drive wheel of a motor vehicle to propel same.

To transmit the torque in a targeted manner and/or by means of a manual transmission with different transmission ratios, the use of the belt-drive transmission described above is particularly advantageous because a large transmission ratio spread can be achieved in a small space and the drive unit can be operated within a small optimal speed range. Conversely, a receiving of an inertia energy introduced by, for example, a drive wheel, which then forms a drive unit in the above definition, can be implemented by means of the belt-drive transmission on an electric generator for recuperation (the electrical storage of braking energy) with a correspondingly configured torque transmission line. In an example embodiment, a plurality of drive assemblies is provided, which can be operated in series or in parallel or can be operated in a decoupled manner from each other and the torque of which can be made available as required by means of a belt-drive transmission according to the above description. One exemplary application is a hybrid drive train comprising an electric machine and an internal combustion engine.

The belt-drive transmission proposed here enables the use of a slide rail in which very good damping properties can be achieved due to a narrow slide channel over a large operating range. The noise emissions of such a drive train are thus reduced. The efficiency can also be increased as a result of a reduction in the vibrations. At the same time, by means of the at least one insert element, a low wear can be achieved on the belt and/or the slide rail, and the service life of the belt-drive transmission can thus be extended.

According to a further aspect, a motor vehicle is proposed, including at least one drive wheel which can be driven by means of a drive train according to an embodiment as described above.

Most motor vehicles today have a front-wheel drive and sometimes arrange the drive unit, for example an internal combustion engine and/or an electric machine, in front of the driver's cab and transversely to the main direction of travel. The radial installation space is small in such an arrangement, and it is therefore advantageous to use a small-sized belt-drive transmission. The use of a belt-drive transmission in motorized two-wheeled vehicles is similar, for which an ever-increasing performance is required compared with the previously known two-wheeled vehicles with the same installation space. With the hybridization of the drive trains, this problem is also exacerbated for rear axle arrangements, and also here both in the longitudinal arrangement and in the transverse arrangement of the drive units.

In the motor vehicle proposed here with the drive train described above, low noise emission is achieved, which means that less effort is required with regard to sound insulation. This means that less space is required for the belt-drive transmission. It is also possible, alternatively or additionally, to establish low noise emissions and a long service life.

Passenger cars are assigned to a vehicle class according to, for example, size, price, weight and performance, wherein this definition is subject to constant change according to the needs of the market. In the US market, vehicles in the small car class are assigned to the subcompact car class according to the European classification, and in the British market they correspond to the supermini class and the city car class, respectively. Examples of the microcar category are a Volkswagen up! or a Renault Twingo. Examples of the small car category are an Alfa Romeo MiTo, Volkswagen Polo, Ford Ka+, or Renault Clio. Well-known full hybrids in the small car category are the BMW i3, Audi A3 e-tron or Toyota Yaris Hybrid.

### BRIEF DESCRIPTION OF THE DRAWINGS

The above disclosure is explained in detail below based on the relevant technical background with reference to the associated drawings, which show example embodiments. The disclosure is in no way restricted by the purely schematic drawings, and it should be noted that the drawings are not dimensionally accurate and are not suitable for defining proportions. In the figures,

FIG. 1 schematically represents a slide rail with an undulating slide channel;

FIG. 2 schematically represents a slide rail with a curved slide channel;

FIG. 3 schematically represents a slide rail with a curved slide surface on one side;

FIG. 4 schematically represents a slide rail with material recesses;

FIG. 5 represents a belt-drive transmission with a strand guided by a slide rail; and

FIG. 6 represents a drive train in a motor vehicle with a belt-drive transmission.

### DETAILED DESCRIPTION

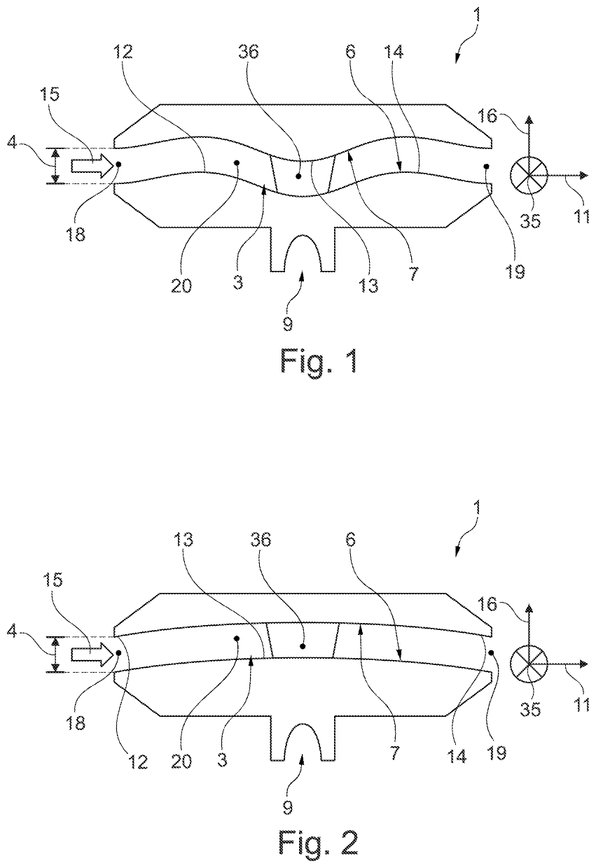

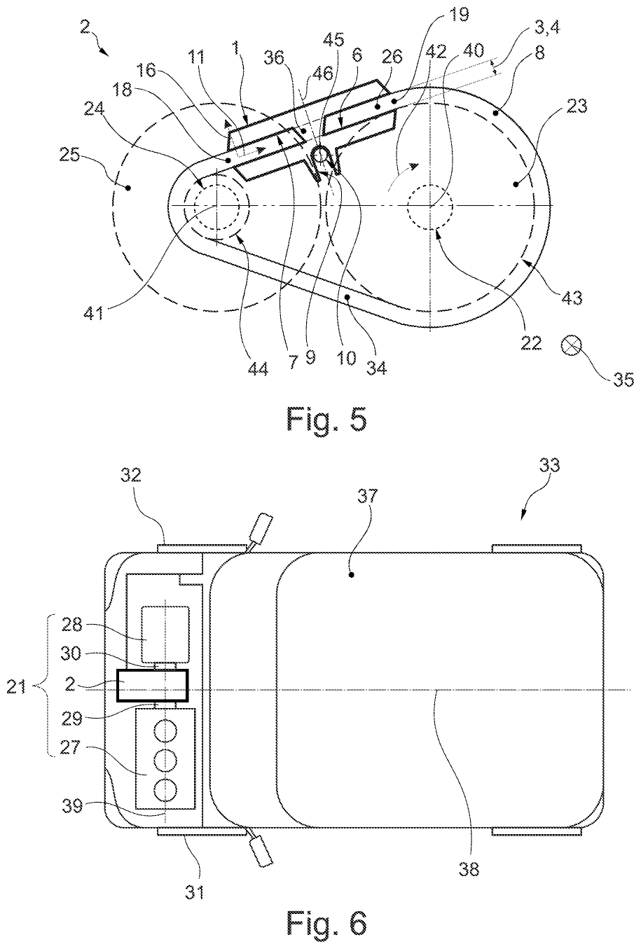

FIG. 1 shows a schematic view of a slide 1 from the side, so that in the illustration in the plane of the sheet, the longitudinal direction 1I extends horizontally and the transversal direction 16 extends vertically, and the axial direction 35 extends vertically into (or out of) the plane of the page. The running direction of the strand 26 to be guided or to be damped of the belt 8 (see FIG. 5) corresponds to the illustrated arrow direction of the longitudinal direction 11 and thus defines the profile 15 through the slide channel 3, which is formed by the first slide surface 6 and the second slide surface 7 (connected by means of a web 36) of the slide rail 1, which is aligned antagonistically thereto. A pivoting receptacle 9 enables the slide channel 3 to be aligned (see FIG. 5).

In the embodiment shown, a (first) elevation 12 and a (third) elevation 14 are provided in the first slide surface 6 and a (second) elevation 13 is also provided in the second slide surface 7. These elevations 12, 13, 14 form the only contact surfaces of the slide surfaces 6, 7, at least at room temperature and/or with an ideally tangential strand 26 (see FIG. 5). As a result of the small extent of the total contact surface, excessive clamping during the cold start is reliably prevented. In an operating state, however, further regions of the slide surfaces 6, 7 also act as contact surfaces. Alternatively, an undulating profile 15 is imposed on the strand 26 to be guided of the belt 8 (see FIG. 5). For example, the (first) channel height 4 is constant over the entire longitudinal extent of the slide channel 3 and thus the geometry of the slide channel 3 is (purely) undulating.

FIG. 2 shows a further embodiment of a slide rail 1 which, for the sake of clarity, is shown in a manner similar to the embodiment according to FIG. 1. In this respect, reference is also made to the above description. Here the (first) channel height 4 of the slide channel 3 is constant and the (first) channel height 4 is only transversely displaced, specifically here such that the slide channel 3 has a curved geometry.

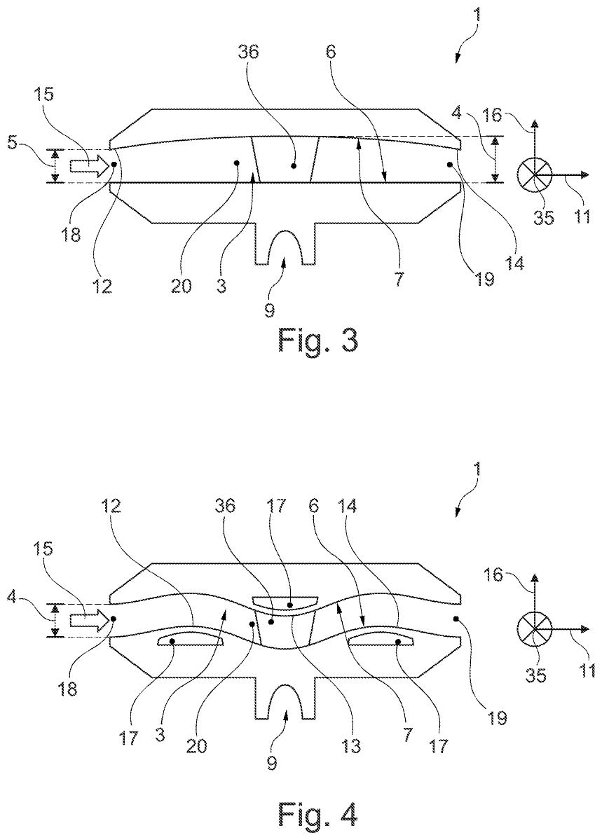

FIG. 3 shows a further embodiment of a slide rail 1 which, for the sake of clarity, is shown in a manner similar to the embodiments according to FIG. 1 and FIG. 2. In this respect, reference is also made to the above description. Here, the second (here outer) slide surface 7 is designed to be curved, for example, like the second slide surface 7 as shown in FIG. 2. The first (here inner) slide surface 6, on the other hand, is designed to be flat. The displacement of the (first) channel height 4 is thus superimposed by an expansion with the maximum of the resulting (second) channel height 5 in the center of the slide channel 3, i.e., at the web 36.

FIG. 4 shows a further embodiment of a slide rail 1 which, for the sake of clarity, is shown in a manner similar to the embodiments according to FIG. 1, FIG. 2 and FIG. 3. In this respect, reference is also made to the above description. A displacement of the (first) channel height 4, for example with a parallel first slide surface 6 and second slide surface 7, is shown here, for example as shown in FIG. 1. Here (optionally) each of the elevations 12, 13 and 14 is provided with a material recess 17, so that a small wall thickness is produced in the region of the elevations 12, 13 and 14, which can be formed by the strand 26 to be guided of the belt 8 (see FIG. 5). The geometry of the slide channel 3 is thus changed as a function of the (force) action of the strand 26 to be guided.

FIG. 5 schematically shows a slide rail 1 in a belt-drive transmission 2, wherein a first side 26 of a belt 8 is guided by means of the slide rail 1 and is thus damped. The belt 8 connects a first cone pulley pair 23 to a second cone pulley pair 25 in a torque-transmitting manner. A first radius of action 43, on which the belt 8 runs, rests on the first (here input-side) cone pulley pair 23 through a corresponding spacing in the axial direction 35 (corresponding to the orientation of the rotation axes 40, 41), which here for example is rotatably connected in a torque-transmitting manner with a transmission input shaft 22 around an input-side axis of rotation 40. A second radius of action 44, on which the belt 8 runs, rests on the second (here output-side) cone pulley pair 25 through a corresponding spacing in the axial direction 35, which here for example is rotatably connected in a torque-transmitting manner with a transmission output shaft 24 around an output-side axis of rotation 41. The (changeable) ratio of the two radii of action 43, 44 results in the transmission ratio between the transmission input shaft 22 and the transmission output shaft 24.

Between the two cone pulley pairs 23, 25, the first strand 26 (shown here) and the second strand 34 are shown in an ideal tangential orientation, so that the parallel direction of the longitudinal direction 11 is established. The transversal direction 16 shown here is defined as the third spatial axis perpendicular to the longitudinal direction 11 and perpendicular to the axial direction 35, wherein this is understood as a (radius of action-dependent) coordinate system moving along therewith. Therefore, both the longitudinal direction 11 shown and the transversal direction 16 apply only to the slide rail 1 shown and the first strand 26, and only in the case of the set input-side radius of action 43 and corresponding output-side radius of action 44 shown.

The slide rail 1 rests with its first (here transversely inner) slide surface 6 and its second (here transversely outer) slide surface 7 connected to it by means of the web 36 on the first strand 26 of the belt 8. So that the slide surfaces 6, 7 can follow the variable tangential orientation, i.e., the longitudinal direction 11, when the radii of action 43, 44 change, the pivoting receptacle 9 is mounted on a pivoting means 10 with a pivot axis 45, for example a conventional holding tube. As a result, the slide rail 1 is mounted pivotably about the pivot axis 45. In the exemplary embodiment shown, the pivot movement is composed of a superposition of a pure angular movement and a transverse movement along a transversal axis 46, so that in deviation from a movement along a circular path, a movement along an oval (steeper) curved path occurs.

In the direction of rotation 42 shown by way of example, and when the torque is input via the transmission input shaft 22, the slide rail 1 in the illustration forms the inlet side on the left and the outlet side on the right. When running as a traction mechanism drive, the first strand 26 then forms the load strand 26 as the driving strand and the second strand 34 forms the empty strand 34. The travel direction 31 corresponds to the illustrated arrow direction of the longitudinal direction 11. If the belt 8 is designed as a thrust link belt, under otherwise identical conditions, either the first strand 26 is guided as an empty strand by means of the slide rail 1 or the first strand 26 is designed as a load strand and a slack strand and:

the direction of rotation 42 and the travel direction 31 are reversed when torque is input via the first cone pulley pair 23; or
the transmission output shaft 24 and the transmission input shaft 22 are interchanged so that the second cone pulley pair 25 forms the torque input.

FIG. 6 shows a drive train 21 arranged in a motor vehicle 33 with the motor axis 39 thereof (optionally) transverse to the longitudinal axis 38 (optionally) in front of the driver's cab 37. The belt-drive transmission 2 is connected on the input side to the electric drive shaft 30 of the electric machine 28 and to the combustion engine drive shaft 29 of the internal combustion engine 27. From these drive units 27, 28 or via their drive shafts 29, 30, a torque for the drive train 21 is delivered simultaneously or at different times. However, a torque can also be received by at least one of the drive units 27, 28, for example by means of the internal combustion engine 27 for engine braking and/or by means of the electric machine 28 for recuperation of braking energy. On the output side, the belt-drive transmission 2 is connected to a purely schematically illustrated output, so that here a left drive wheel 31 (consumer) and a right drive wheel 32 (consumer) can be supplied with torque by the drive assemblies 27, 28 with a variable transmission ratio.

The slide rail proposed here provides efficient damping over a wide operating range while simultaneously preventing excessive clamping.

### REFERENCE NUMERALS

1 Slide rail
2 Belt-drive transmission
3 Slide channel
4 First channel height
5 Second channel height
6 First slide surface
7 Second side surface
8 Belt
9 Pivoting receptacle
10 Pivoting means
11 Longitudinal direction
12 First elevation
13 Second elevation
14 Third elevation
15 Profile
16 Transversal direction
17 Material recess
18 First edge region
19 Second edge region
20 Central region
21 Drive train
22 Transmission input shaft
23 First cone pulley pair
24 Transmission output shaft
25 Second cone pulley pair
26 Load strand
27 Internal combustion engine
28 Electric machine
29 Combustion drive shaft
30 Electric drive shaft
31 Left drive wheel
32 Right drive wheel
33 Motor vehicle
34 Empty strand
35 Axial direction
36 Web
37 Drivers cab
38 Longitudinal axis
39 Motor axis
40 Input-side axis of rotation
41 Output-side axis of rotation
42 Direction of rotation
43 Input-side radius of action
44 Output-side radius of action
45 Pivot axis
46 Transversal axis

1.-8. (canceled)

9. A slide rail for a belt-drive transmission, comprising:
a slide channel comprising:
a first slide surface for damping contact on a strand of a belt of the belt-drive transmission;
a second slide surface for damping contact on the strand, antagonistic to the first slide surface; and
a channel height formed by the first slide surface and the second slide surface; and
a pivoting receptacle arranged for pivoting support of the slide rail on a pivoting means of the belt-drive transmission, wherein a one of the first slide surface or the second slide surface comprises an elevation extending toward the belt such that the one of the first slide surface or the second slide surface is displaced over a profile along a longitudinal direction in a transversal direction.

10. The slide rail of claim 9 further comprising a material recess formed on a rear side of the first slide surface or the second slide surface.

11. The slide rail of claim 10 wherein the material recess is formed in a region of a reduced channel height or of the elevation, projecting in the transversal direction towards the belt.

12. The slide rail of claim 9 further comprising:
a central region having a first channel height; and
an edge region comprising a second channel height.

13. The slide rail of claim 12 wherein the first channel height is higher or lower than the second channel height.

14. The slide rail of claim 9, wherein the first slide surface is flat and the second slide surface is curved.

15. The slide rail of claim 9, wherein the first slide surface and the second slide surface are designed to run parallel to one another.

16. A belt-drive transmission for a drive train, comprising:
a transmission input shaft comprising a first cone pulley pair;
a transmission output shaft comprising a second cone pulley pair;
the belt connecting the first cone pulley pair to the second cone pulley pair in a torque-transmitting manner, the belt forming two strands between the first cone pulley pair and the second cone pulley pair; and
the slide rail of claim 9, wherein the first slide surface or the second slide surface rests on a one of the two strands.

17. A drive train comprising:
the belt-drive transmission of claim 16;
a consumer; and
a drive assembly comprising a drive shaft connectable to the consumer for torque transmission with a changeable transmission ratio by the belt-drive transmission.

18. A motor vehicle comprising a drive wheel drivable by the drive train of claim 17.
